(19) United States
(12) Patent Application Publication
(10) Pub. No.: US 2022/0121933 A1
(43) Pub. Date: Apr. 21, 2022

(54) Device and Method for Training a Neural Network

(71) Applicant: Rockwell Collins Deutschland GmbH, Heidelberg (DE)

(72) Inventor: Michael Feigenbutz, Leimen (DE)

(21) Appl. No.: 17/424,551

(22) PCT Filed: Jan. 17, 2020
(86) PCT No.: PCT/EP2020/051170

§ 371 Date: Jul. 21, 2021

(30) Foreign Application Priority Data
Jan. 23, 2019 (DE) 10 2019 101 617.7

(51) Int. Cl. G06N 3/08

(52) U.S. Cl. CPC G06N 3/08

(57) ABSTRACT

A method for training a neural network has the steps of:—providing a neural network (8), which is to be trained, for providing a prescribed functionality for processing input data (10), having an input for supplying the input data (10) and an output for outputting output data (11) serving as results;—providing an evaluation device (1) for providing a prescribed functionality, having an input for supplying input data (3) and an output for outputting output data (4) serving as results;—operating the evaluation device (1) and the neural network (8) in parallel with one another;—comparing the output data (4) from the evaluation device (1) with the output data (11) from the neural network (8) and determining the quality of the output data (11) from the neural network (8) in relation to the output data (4) from the evaluation device (1);—reporting the quality of the output data (11) to the neural network (8).

### TECHNICAL FIELD

The invention relates to a device and method for training a neural network.

### BACKGROUND

Neural networks are well known. They are, in particular, implemented as artificial neural networks for technical purposes and serve, e.g., for the processing of information in applications where there is little or no explicit or systematic knowledge about the problem to be solved. These are, for example, recognition methods such as text recognition, image recognition, object recognition and face recognition, in which a few hundred thousand to millions of pixels have to be converted into a comparatively small number of permitted results. (Artificial) neural networks are also used in control technology to replace conventional controllers or specify setpoints for them that the network has determined from a self-developed prognosis about the course of the process. The application possibilities are, however, not limited to technical or technology-related areas. When predicting changes in complex systems, neural networks are often used as support, for example, for the early detection of looming tornadoes or for assessing the further development of economic processes.

To achieve the desired functionality of a neural network, it is necessary that the neural network is learned or trained. Accordingly, learning methods are known which serve to induce a neural network to generate associated output patterns for certain input patterns. The learning methods can be classified into supervised learning, unsupervised learning and reinforcement learning.

In supervised learning it is necessary to learn the neural network with a large amount of test data. This amount of test data has to be generated in advance, with the generation of these datasets usually being very time-consuming and, depending on the application, also difficult.

Successfully learned (trained) neural networks offer the advantage over conventional solutions that they are often a faster and/or more cost-effective possibility, and possibly even the only possibility to efficiently process large amounts of data.

Depending on the application, hundreds of thousands or even millions of test datasets are required for the training phase of neural networks. For certain very specific applications (for example, the airborne identification of smaller objects), such data, in particular, also in connection with specific sensors such as imaging RADAR, LIDAR, IR, etc., is not (yet) available and also cannot be efficiently generated in the required quantity.

On the other hand, neural networks can be relatively inexpensive to set up, implement and operate, so that they can be used to replace conventional (expensive) systems.

### SUMMARY

The invention is therefore based on the object of providing a device and method with which a neural network can be efficiently trained.

[symbol]

A device for training a neural network is specified, comprising a neural network to be trained to perform a predetermined functionality for processing input data, having an input for supplying the input data and an output for outputting output data serving as results, and comprising an evaluation device for performing a predetermined functionality, having an input for supplying input data and an output for outputting output data serving as results. The evaluation device and the neural network are arranged in parallel to one another, with a comparison means being provided for comparing the output data of the evaluation device with the output data of the neural network and for determining the quality of the output data of the neural network in relation to the output data of the evaluation device. Furthermore, a feedback means is provided for reporting back to the neural network the quality of the output data determined by the comparison means.

Analogously, a method for training a neural network is specified, comprising the steps of:
providing a neural network to be trained to perform a predetermined functionality for processing input data, having an input for supplying the input data and an output for outputting output data serving as results;
providing an evaluation device for performing a predetermined functionality, having an input for supplying input data and an output for outputting output data serving as results;
operating the evaluation device and the neural network in parallel to one another;
comparing the output data of the evaluation device with the output data of the neural network and determining the quality of the output data of the neural network in relation to the output data of the evaluation device;
reporting back to the neural network the quality of the output data.

In accordance with the invention, the evaluation device and the neural network can, accordingly, be arranged or switched in parallel to one another. The evaluation device can be a well-known, conventional system which—under certain circumstances in conformity with given technical rules and standards—already reliably fulfills the desired functionality. In particular, however, the evaluation device can be relatively expensive, so that it is endeavored to replace the evaluation device with the neural network to be trained in advance.

In this process, the evaluation device takes on the training of the neural network by operating it in parallel. The evaluation device can therefore also be referred to as a training device.

As explained, the evaluation device can be a conventional device which is not based on a neural network. Similarly, however, it is also possible for the evaluation device itself to have a neural network, which is then, however, already fully learned or trained.

The term “functionality” can be understood to mean any applications, tasks or goals that are to be achieved by the evaluation device on one hand and the neural network to be trained on the other hand.

When the evaluation device and the neural network are operated in parallel to one another, both systems are thus confronted with preferably identical input situations. Only then is it possible to transfer the behavior and knowledge of one system (the proven evaluation device) to the other system (the neural network to be learned). The more similar the input situations and thus the resulting input data, the more reliably the neural network can be trained.

The comparison means serves to compare the (substantially correct and proven) output data of the evaluation device with the output data of the neural network and thereby determine the quality of the output data of the neural network in relation to the output data of the evaluation device. In this process, the data is, in particular, evaluated so that the subsequent required feedback can be achieved with the aid of the feedback means.

The feedback means is configured to report back to the neural network the quality of the output data determined by the comparison means in order to bring about in this manner a training effect for the neural network and thus subsequently an improvement in the quality of the output data of the neural network.

The “quality” of the output data can be understood to mean, for example, the correctness of the probabilities supplied by the neural network (also referred to as “prediction”). Usually, neural networks are configured to determine certain probabilities and draw conclusions from them. These probabilities can be compared with the substantially more precise data of the (conventional) evaluation device, with the result being reported back to the neural network.

An example: A dog is presented to a neural network via a connected video camera. Based on its training status, the neural network indicates that the object presented can be 80% a dog, 80% a cat or 10% a fish. The quality of these results is then determined and fed back into the neural network as feedback:

dog: correct (the probability value of 80% can still be improved, towards 100%),

cat: wrong (the probability value of 80% is incorrect and should be lower),

fish: correct (because a very low probability has already been determined at 10%; but should be set at 0%).

In a subsequent recognition process under similar conditions, the probability for “dog” will then be greater than 80%, while that for “cat” will be lower. The one for “fish” will also be less than 10%.

For reporting back to the neural network the quality information regarding the output data, common methods can be used, such as backpropagation, feedback, backpropagation of error.

During the training phase, the neural network learns from the given learning material. The weights between the individual neurons are usually modified accordingly. Learning rules specify the way in which the neural network makes these changes. The device and the method according to the invention allow neural networks to be learned in an automated manner and, in this process, dispense with the prior generation of test datasets. Rather, real datasets are generated during operation of the (conventional) evaluation device which can be used to train the neural network.

For this purpose, an already existing solution (conventional evaluation device) is combined with a new solution based on a neural network during the learning phase (training phase). In this process, it is possible that combined systems of different sensors can then be used for them both. In this process, the existing solution takes on the training of the new solution (of the neural network).

The input and output parameters of the existing solution are used to generate the feedback for the reporting back (for example, the so-called backpropagation) of the neural network.

After the automated (“online”) learning phase, the conventional, often slower and/or more expensive conventional mechanism (evaluation device) and its components (sensors, computers) can be dispensed with. Similarly, however, it is also possible to operate the new solution (neural network) in parallel in order to upgrade the overall system with additional properties and, for example, improve the quality of the results.

The input data for the evaluation device and the input data for the neural network can, in each case, be provided by a sensor device. Any type of measured value recording is suitable as a sensor device, such as a (video) camera, a video sensor (e.g., IR), an imaging RADAR sensor, a LIDAR sensor, a 2D camera, a 3D camera, a microphone. The sensor device is configured to generate the input data in a way that it can be processed by the neural network or the evaluation device. Naturally, additional components can also be interconnected in order to prepare the data accordingly if this is necessary due to the characteristics of the sensor device.

The input data for the evaluation device and the input data for the neural network can be provided by different sensor devices. It is therefore not absolutely necessary for the two sensor devices to be constructed identically. For example, it is possible to couple the evaluation device to a video sensor while the neural network receives input data from a LIDAR sensor.

The evaluation device and the associated sensor device can deliver output data in a satisfactory quality. As explained above, the evaluation device is a traditional or conventional system that has already been able in the past to deliver output data in a quality that corresponds to the particular requirements. The requirements can, for example, be specified by technical rules and standards or by the manufacturer. “Satisfactory quality” is therefore to be understood to mean that the quality is sufficient to fulfill the intended purpose or the desired functionality.

The quality can also be regarded as satisfactory if a defined minimum percentage recognition rate or—conversely—a defined maximum error rate is achieved in relation to the “objects” to be recognized.

After reaching a satisfactory quality or after reaching a predetermined quantum of feedback (e.g., a hundred thousand, a million or the like), completion of the training phase can be determined. The training of the neural network should be carried out as efficiently as possible and can therefore be terminated when the neural network delivers results of satisfactory quality.

In particular, this state can be reached when only minor or negligible deviations of the results of the neural network from those of the evaluation device are determined. Similarly, it is also possible to determine the number of iterations or feedback and, when reaching a predetermined number of datasets (e.g., a hundred thousand or millions), assume that the neural network has been sufficiently trained. In these cases, the completion of the training phase is determined so that the neural network can subsequently also be operated independently.

After completion of the training phase, the evaluation device can be separated from the neural network, with the neural network being able to operate independently without the need for continued parallel operation of the evaluation device. The neural network can then be operated in isolation, without the evaluation device. The evaluation device can thus be removed from the arrangement.

In one variant, the evaluation device and the neural network can be operated in parallel after the completion of the training phase. In this case, the evaluation device and the neural network can complement one another, so that the quality of work of the overall system consisting of both systems can be improved. Similarly, it is also possible to provide additional properties.

For example, a system with an evaluation device and a video sensor can be supplemented by a neural network with an imaging RADAR, IR or LIDAR sensor in order to recognize objects in an input image at high precision from the sum of the findings.

Neural networks can be used for a wide range of functionalities, where the predetermined functionality can be selected from the group of recognition of one or more objects, recognition of texts, writing, images, patterns, vehicles, people or faces, detection of spatial correlations, optimization processes, control and analysis of complex processes, early warning systems, optimization, time series analysis, speech generation, data mining, machine translation, medical diagnostics, epidemiology, biometrics, sound systems, navigation with imaging sensors, recognition of chronological sequences, predictive maintenance, etc.

### BRIEF DESCRIPTION OF THE DRAWINGS

These and additional advantages and features will be explained in more detail in the following text, based on examples with the aid of the accompanying figures, in which:

FIG. 1 shows a schematic representation of a conventional system with a conventional evaluation device;

FIG. 2 shows a device according to the invention for training a neural network; and

FIG. 3 shows an example of an application of an already trained neural network.

### DETAILED DESCRIPTION

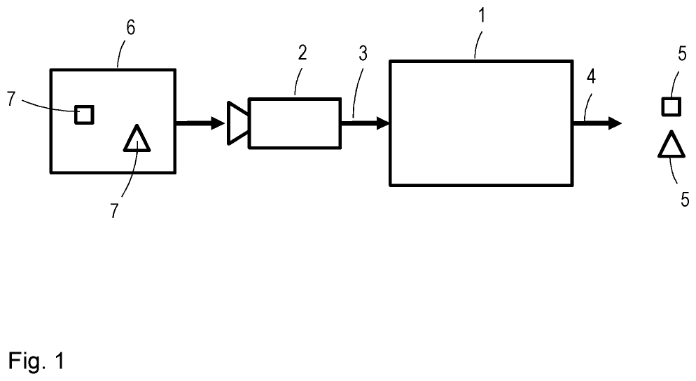

FIG. 1 shows a schematic representation of the structure of a conventional system with a conventional evaluation device 1 which is coupled to a video sensor 2.

The evaluation device 1 known per se is, in the example shown, configured to carry out video-based object recognition. For example, it is able to recognize objects based on input data 3 generated by the video sensor 2 and supply information about identified (classified) objects 5 as output data 4.

In the example shown, a real situation 6 with real objects 7 is recorded by the video sensor 2 and supplied to the evaluation device 1 in the form of input data 3. The functionality of the evaluation device 1 enables to determine information about the real objects 7 from the input data 3 and output it in the form of the output data 4, so that the objects 5 identified (recognized by the evaluation device 1) are thereby determined as results of the evaluation device 1.

Such proven systems for object recognition can, e.g., be used for the recognition of traffic signs by passenger cars or the recognition of pedestrians by autonomous vehicles. Similarly, these systems can, for example, be used to recognize objects on conveyor belts.

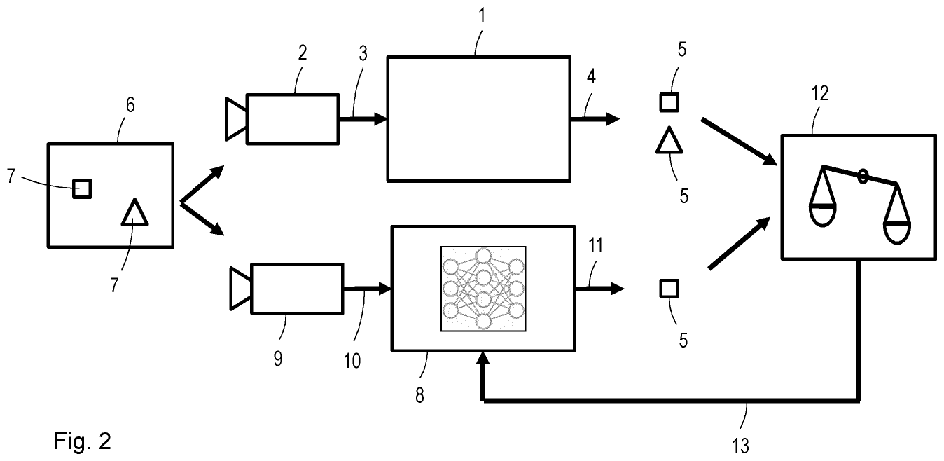

FIG. 2 shows an example of a device according to the invention for training a neural network.

Part of this device is the evaluation device 1 with the video sensor 2 already explained in connection with FIG. 1. The real objects 7 in the real situation 6 can thus be output by the evaluation device as output data 4 with the identified objects 5 as the result.

In parallel to the evaluation device 1, a neural net 8 (also referred to as a neural network) is arranged, which is to be trained by the evaluation device 1. The neural net 8 is thus at first in an initial state not yet able to deliver satisfactory results.

The neural net 8 can also be coupled to a video sensor 2. In the concrete example, however, the neural net 8 is coupled to a LIDAR sensor 9. LIDAR (also called LADAR) is a radar-related method for optical distance and speed measurement using laser beams. LIDAR sensors have proven themselves especially for the detection of three-dimensional situations.

The LIDAR sensor 9 is confronted with the same real situation 6 and thus with the same real objects 7 as the video sensor 2 or the evaluation device 1.

The LIDAR sensor 9 thus supplies its own input data 10, which is processed in the neural net 8. The results of the neural net 8 are provided as output data 11 and, in particular, consist of weightings. The results or weightings result in corresponding findings regarding the identified objects 5. The results are usually also given as probabilities (“prediction”).

Of course, a plurality of sensors can also be coupled to the neural network 8 if this makes sense for the planned application.

In the example shown in FIG. 2, it can be seen that the neural net 8 is still incompletely trained and has only recognized the square as the only identified object 5 of the two real objects 7, but not the triangle as a further real object 7. For the reliable detection of the triangle, the neural net 8 must therefore be further trained.

The results of the evaluation device 1 and of the neural net 8 in the form of the output data 4, 11 are fed into a comparison means 12, which evaluates the results of the neural net 8, in particular, in comparison to the results of the evaluation device 1. In this process, the output data 4, 11 can be compared with one another, in order to determine the quality of the output data 11 of the neural net 8 in relation to the output data 4 of the evaluation device 1 in this way.

The findings of the comparison means 12 are fed back to the neural net 8 with the aid of a feedback means 13. The feedback serves, in particular, as backpropagation of error to correct errors in the neural net. The feedback is often referred to as “backpropagation” and can be implemented using known methods.

A proven method is, for example, the gradient descent method, which starts with a randomly selected weight combination for which the gradient is determined and descended by a predetermined length—the learning rate. This changes the weights accordingly. The gradient is again determined for the newly obtained weight combination, and the weights are modified again. This process is repeated until a local minimum or global minimum is achieved, or a previously determined maximum number of repetitions has been reached.

In this way, the neural net 8 is trained, so that the results it produces come closer and closer to the results of the proven, conventional evaluation device 1.

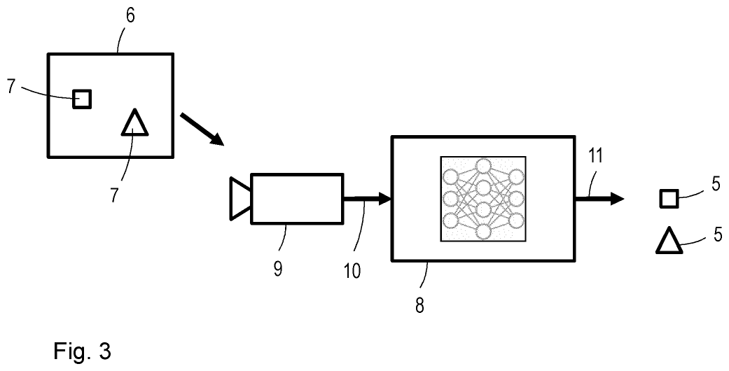

Finally, it is possible to decouple the (sufficiently trained) neural net 8 from the evaluation device 1, as shown by FIG. 3.

The evaluation device 1 is no longer required in this case.

The neural net 8 can be operated independently in accordance with the structure of FIG. 3 and provides results of sufficient quality. Thus, in the example shown, the neural net 8 is suitable for identifying both the square and the triangle as identified objects 5.

Since the neural net 8 can be operated in parallel to the conventional evaluation device 1, it is possible without any problems to also train the neural net 8 in real operation, i.e. in real use of the evaluation device 1. The “test data” generated by the evaluation device 1 is concretely usable data that can, virtually as “by-products”, also be used for training the neural net 8. It is therefore not necessary to set up an independent training phase. Rather, the training could take place in the normal control mode of the evaluation device 1.

The use of new sensors for the evaluation by a neural network is, in particular, simplified where little or no training data is available. In addition, the method can enable the neural network to continuously continue to learn even over a longer period of time, in order to increase the reliability of the neural network more and more.

1-9. (canceled)

10. A device for training a neural network, the device comprising:
a neural network configured to be trained to perform a predetermined functionality for processing input data, having an input configured to supply the input data and an output configured to output output data serving as results; and
an evaluation device configured to perform a predetermined functionality, having an input configured to supply input data and an output configured to output output data serving as results,
wherein the evaluation device is not based on a neural network,
wherein the evaluation device and the neural network are arranged in parallel to one another,
wherein a comparison means is provided for comparing the output data of the evaluation device with the output data of the neural network and for determining the quality of the output data of the neural network in relation to the output data of the evaluation device,
wherein a feedback means is provided for reporting back to the neural network the quality of the output data determined by the comparison means.

11. The device of claim 10, wherein the predetermined functionality is selected from the group consisting of:
recognition of one or more objects;
recognition of texts, writing, images, patterns, vehicles, people or faces;
detection of spatial correlations;
optimization;
control and analysis of complex processes;
early warning systems;
optimization;
time series analysis such as weather or stocks;
speech recognition and generation;
data mining;
machine translation;
medical diagnostics, epidemiology, biometrics;
sound systems;
navigation with imaging sensors;
recognition of chronological sequences; and
predictive maintenance.

12. A method for training a neural network, the method comprising:
providing a neural network to be trained to perform a predetermined functionality for processing input data, having an input configured to supply the input data and an output configured to output output data serving as results;
providing an evaluation device for performing a predetermined functionality, having an input configured to supply input data and an output configured to output output data serving as results, wherein the evaluation device is not based on a neural network;
operating the evaluation device and the neural network in parallel to one another;
comparing the output data of the evaluation device with the output data of the neural network and determining the quality of the output data of the neural network in relation to the output data of the evaluation device; and
reporting back to the neural network the quality of the output data.

13. The method of claim 12, wherein the input data for the evaluation device and the input data for the neural network are, in each case, provided by a sensor device.

14. The method of claim 12, wherein the input data for the evaluation device and the input data for the neural network are provided by different sensor devices.

15. The method of claim 12, wherein the evaluation device and the associated sensor device supply output data in a satisfactory quality.

16. The method of claim 12, wherein after achieving a satisfactory quality or after achieving a predetermined quantum of feedbacks, completion of a training phase is detected.

17. The method of claim 12, wherein after completion of the training phase, the evaluation device is separated from the neural network, and wherein the neural network is operated independently without the evaluation device being operated in parallel.

18. The method of claim 12, wherein after completion of the training phase, the evaluation device and the neural network are operated in parallel.

19. The method of claim 12, wherein the predetermined functionality is selected from the group consisting of:
recognition of one or more objects;
recognition of texts, writing, images, patterns, vehicles, people or faces;
detection of spatial correlations;
optimization;
control and analysis of complex processes;
early warning systems;
optimization;
time series analysis such as weather or stocks;
speech recognition and generation;
data mining;
machine translation;
medical diagnostics, epidemiology, biometrics;
sound systems;
navigation with imaging sensors;
recognition of chronological sequences; and
predictive maintenance.
